(19) United States
(12) Patent Application Publication
(10) Pub. No.: US 2026/0289950 A1
(43) Pub. Date: Sep. 24, 2026

(54) SYSTEMS AND METHODS FOR IMAGING AN OBJECT

(71) Applicant: WARBY PARKER INC., New York, NY (US)

(72) Inventors: Patrick Stock, New York, NY (US); Dee Celeste Goldberg, New York, NY (US); David J. DeShazer, New York, NY (US); Ravi Jindal, New York, NY (US); Richard Yeh, New York, NY (US); Brian Ziegler, New York, NY (US)

(73) Assignee: WARBY PARKER INC., New York, NY (US)

(21) Appl. No.: 19/472,542

(22) PCT Filed: Apr. 17, 2024
(86) PCT No.: PCT/US2024/024988

§ 371 Date: Oct. 3, 2025

Related U.S. Application Data
(60) Provisional application No. 63/460,779, filed on Apr. 20, 2023.

(51) Int. Cl. G06V 10/44; G06V 10/74; G06V 20/60

(52) U.S. Cl. CPC G06V 10/44; G06V 10/74; G06V 20/60

(57) ABSTRACT

A method includes obtaining an image of an object disposed on a reference pattern; identifying a search band in the image and identifying a plurality of locations within the search band. Each of the plurality of locations corresponds to an edge of the object in the image. The method may include storing a trace for the object extracted from the in a computer-readable storage medium. Fixtures and systems also are disclosed.

### CROSS-REFERENCE TO RELATED APPLICATIONS

This application claims priority to U.S. Provisional Patent Application No. 63/460,779, filed Apr. 20, 2023, the entirety of which is incorporated by reference herein.

### FIELD OF DISCLOSURE

The disclosed systems and methods relate to computer vision and imaging. More particularly, the disclosed systems and methods relate to using computer vision and imaging to determine an edge of an object, such as a lens and/or frames for spectacles.

### BACKGROUND

Many companies offer replacement lenses for glasses or spectacles, which may be necessary if a customer's prescription changes or if a lens becomes damaged. In many situations, a store or kiosk may not have a lens tracer on premises because lens tracers are expensive. In such situations, the customer's lenses are shipped to an off-site facility that has a lens tracer and then sent back to store or directly to the customer. Due to the shipping times, the process of having lenses traced at an off-site facility may take one-to-two weeks, which is not ideal for customers.

### SUMMARY

In some embodiments, a method includes obtaining an image of an object disposed on a reference pattern; identifying a search band in the image and identifying a plurality of locations within the search band. Each of the plurality of locations corresponds to an edge of the object in the image. The method may include storing a trace for the object extracted from the in a computer-readable storage medium.

In some embodiments, a method includes determining a radial gradient in the image with respect to a reference point. The search band in the image may be identified based on the radial gradient.

In some embodiments, a method includes, prior to determining the radial gradient in the image, converting the image from a first coordinate system to a second coordinate system.

In some embodiments, the first coordinate system includes a Cartesian coordinate system and wherein the second coordinate system includes a polar coordinate system.

In some embodiments, prior to storing the trace for the lens, a method includes converting the plurality of locations within the search band from the second coordinate system to the first coordinate system.

In some embodiments, prior to storing the trace for the lens, a method includes adjusting an orientation of the trace of the lens.

In some embodiments, adjusting the orientation of the trace of the lens includes: comparing a preliminary trace for the lens with a reference trace; and identifying a rotation angle for the preliminary trace based on the comparison.

In some embodiments, identifying the search band based on the radial gradient includes limiting a region of interest to a predetermined amount pixels from a determined radial gradient.

In some embodiments, a method includes identifying a contour in the image. Identifying the search band in the image may include identifying a number of pixels at a predetermined distance from the contour.

In some embodiments, the object may include a lens.

In some embodiments, the object may include frames for eyeglasses.

In some embodiments, a fixture for imaging an object includes: an imaging platform including a backlit area having a reference pattern disposed thereon and is configured to support the object, a support surface configured to support a camera, and at least one leg configured to maintain the support surface at distance from the imaging platform.

In some embodiments, the at least one leg includes a plurality of legs.

In some embodiments, the plurality of legs are configured to extend between the support surface and a base portion that is coupled to the imaging platform.

In some embodiments, the plurality of legs are pivotally coupled to at least one of the support surface or the base portion.

In some embodiments, the plurality of legs are fixedly coupled to a base portion that is coupled to the imaging platform and to an upper portion that includes the support surface.

In some embodiments, the upper portion defines an opening and the surface extends at least partially into the opening.

In some embodiments, the reference pattern is configured to be removably coupled to the backlit area.

In some embodiments, the reference pattern has at least one object having a predetermined dimension.

In some embodiments, the at least one leg has an adjustable length.

In some embodiments, the object includes a lens for eyeglasses.

In some embodiments, the object includes a frame for eyeglasses.

In some embodiments, a system includes: a camera, a fixture, and a computing device in signal communication with the camera. The fixture may include a backlit area having a reference pattern and configured to support an object and a support surface configured to support the camera at a distance from the backlit area. The computing device may be configured to: obtain an image of the object and the reference pattern from the camera and extract a trace of the object from the image.

In some embodiments, the camera is a component of the computing device.

In some embodiments, the camera is communicatively coupled to the computing device via at least one of a wired or wireless connection.

In some embodiments, to extract the trace of the object from the image, the computing device is configured to: determine a radial gradient in the image with respect to a reference point, identify a search band based on the radial gradient, and identify a plurality of locations within the search band. Each of the plurality of locations may correspond to an edge of the object in the image.

In some embodiments, the object includes a lens for eyeglasses.

In some embodiments, the object includes a frame for eyeglasses.

In some embodiments, a method may include: placing an object over a reference pattern disposed on a backlit area of an imaging platform, obtaining an image of the object on the reference pattern using a camera, and extracting a trace of the object from the image using a computing device that is communicatively coupled to the camera.

In some embodiments, the object includes a lens for eyeglasses, and a method may include removing the lens from an eyeglass frame prior to placing the lens over the reference pattern.

In some embodiments, a method may include inserting the lens into the eyeglass frame after obtaining the image.

In some embodiments, the lens is placed on the imaging platform such that a concave side of the lens is placed on the imaging platform.

In some embodiments, the object includes a frame for eyeglasses.

### BRIEF DESCRIPTION OF THE DRAWINGS

FIG. 1 is an isometric view of one example of a fixture in an assembled state and supporting a computing device in accordance with some embodiments;

FIG. 2 is an isometric view of the fixture illustrated in FIG. 1 in a state of partial disassembly in accordance with some embodiments;

FIG. 3 is an isometric view of one example of the fixture illustrated in FIG. 1 in a disassembled or storage state in accordance with some embodiments;

FIG. 4 illustrates one example of a reference pattern that may be located on an imaging platform and supported by a fixture in accordance with some embodiments;

FIG. 5 illustrates another example of a reference pattern that may be located on an imaging platform and supported by a fixture in accordance with some embodiments;

FIG. 6 is an isometric view of another example of a fixture supporting a computing device in accordance with some embodiments;

FIG. 7 is another isometric view of the fixture shown in FIG. 7 in accordance with some embodiments;

FIG. 8 is another isometric view the fixture shown in FIG. 7 supporting another computing device in accordance with some embodiments;

FIG. 9 is a block diagram showing the functional components of one example of a computing device in accordance with some embodiments;

FIG. 10 illustrates one example of a system including a plurality of fixtures for imaging a lens in accordance with some embodiments;

FIG. 11 is a flow diagram of one example of imaging a lens in accordance with some embodiments;

FIG. 12 illustrates one example of a lens positioned within a reference frame on a backlit area of an imaging platform in accordance with some embodiments;

FIG. 13 is a flow diagram of one example of extracting a profile of a lens from an image in accordance with some embodiments;

FIG. 14 illustrates one example of a cropped image of a lens positioned within a reference frame in accordance with some embodiments;

FIG. 15 illustrates one example of the cropped image having been binarized in accordance with some embodiments;

FIG. 16 illustrates one example of a contour of the lens having been identified in the binarized image in accordance with some embodiments;

FIG. 17 illustrates one example of a contour of a lens having been extracted in accordance with some embodiments;

FIG. 18 is a flow diagram of another example of extracting a profile of a lens from an image in accordance with some embodiments;

FIG. 19 illustrates one example of a center point of a cropped image having been identified in accordance with some embodiments;

FIG. 20 illustrates one example of a gradient of the cropped image shown in FIG. 19 in polar coordinates in accordance with some embodiments;

FIG. 21 illustrates one example of maximum gradients having been identified in accordance with some embodiments;

FIG. 22 illustrates one example of the maximum gradients after a smoothing process has been performed in accordance with some embodiments;

FIG. 23 illustrates one example of a precision search band in accordance with some embodiments;

FIG. 24 illustrates one example of an edge of a lens identified in the precision search band in accordance with some embodiments;

FIG. 25 is a flow diagram of another example of extracting a profile of a lens from an image in accordance with some embodiments;

FIG. 26 illustrates a plurality of vectors extending from a box of a checkerboard reference pattern to an edge of a lens in an image in accordance with some embodiments;

FIG. 27 is a flow diagram of one example of extracting a shape from an image, in accordance with some embodiments;

FIG. 28 illustrates one example of an image of a lens after preprocessing, in accordance with some embodiments;

FIG. 29 is one example of an output of a preliminary contour extraction process, in accordance with some embodiments;

FIG. 30 illustrates one example of a method of sampling a contour, in accordance with some embodiments;

FIG. 31 illustrates one example of an output of a sampling function, in accordance with some embodiments;

FIG. 32 illustrates one example of a gradient computation, in accordance with some embodiments;

FIG. 33 illustrates one example output of a peak detection algorithm, in accordance with some embodiments;

FIGS. 34-36 illustrates one example of various image processing steps, in accordance with some embodiments; and

FIG. 37 illustrates one example of a process for minimizing and/or reducing error of an edge detection algorithm, in accordance with some embodiments.

### DETAILED DESCRIPTION

This description of the exemplary embodiments is intended to be read in connection with the accompanying drawings, which are to be considered part of the entire written description.

The disclosed systems and methods utilize a specially designed fixture for holding a camera, which may be a standalone camera or a camera incorporated into or attached to a computing device (e.g., a mobile phone, tablet, computer), and computer vision algorithms to enable lenses to be imaged at a store, kiosk, or nearly any other location. The low-cost fixture, in combination with use of a commercially available computing device, avoids the requirement to install expensive lens tracers at every store or kiosk in order to trace a lens accurately.

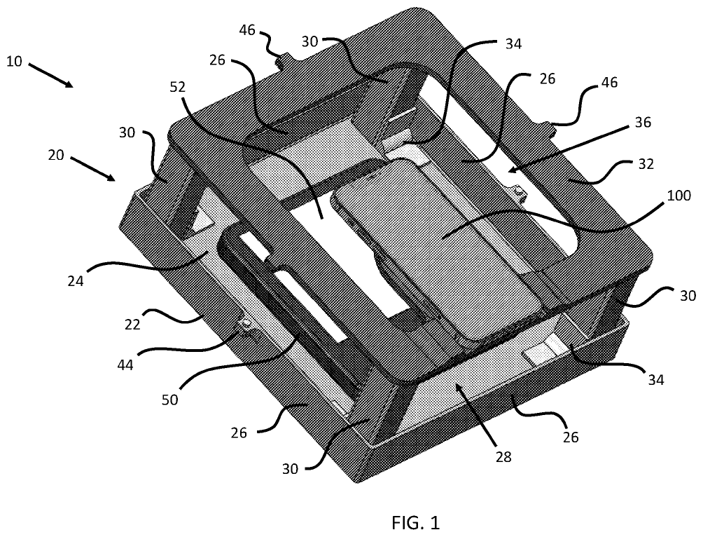

FIG. 1 illustrates one example of a system for imaging a lens, eyeglass frame, or other object in accordance with some embodiments. The system 10 may include a fixture 20 and a computing device 100. The fixture 20 may be configured to support computing device 100 at a known distance from a lens (not shown in FIG. 1) as described herein. In some embodiments, the fixture 20 may include a base portion 22 providing a support surface 24 for an imaging platform 50. The base portion 22 may also include one or more walls 26 extending from the support surface 24. In some embodiments, the one or more walls 26 and support surface 24 may collectively define an interior region or space 28. Although the base portion 22 is shown having a generally square or rectangular shape, it should be understood that base portion 22 may be provided in other shapes.

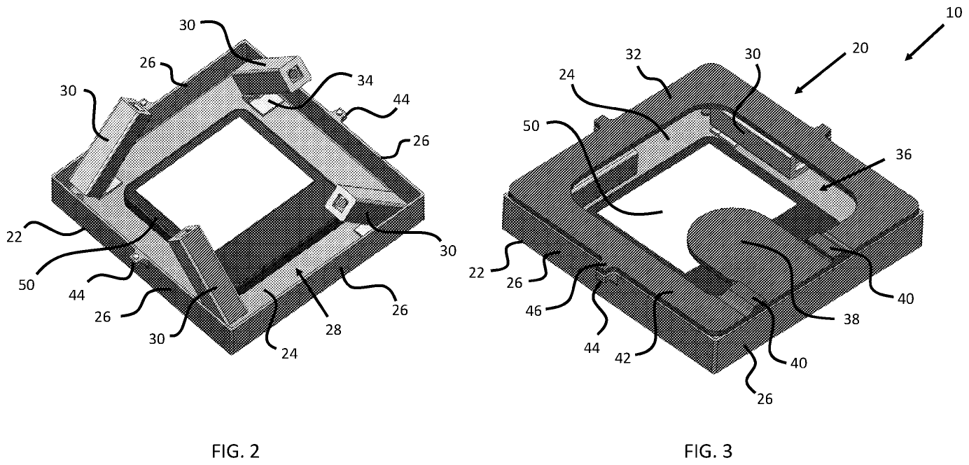

Fixture 20 may include one or more legs or spacers 30, which may couple an upper portion 32 to the base portion 22. In the example illustrated in FIG. 1, four legs 30 are illustrated; however, fewer (e.g., one, two, or three) or more legs 30 may be provided. In some embodiments, legs 30 may be pivotally coupled to the base portion 22 and be removably coupled to upper portion 32 or vice versa to allow the fixture to be collapsed to a smaller size for storage when not in use, as best seen in FIG. 3. For example, the support portion 32 may be removed from its engagement with the one or more legs 30, and the legs may pivoted from a first or upright position (e.g., a position in which the leg(s) 30 extend perpendicularly with respect to support surface 24) to a second or collapsed position (e.g., a position in which the legs 30 extend parallel to support surface 24), as best seen in FIGS. 2 and 3. In the example illustrated in FIG. 3, the legs 30 may have a width that is smaller than a height of the walls 26 such that, in the collapsed position, the legs 30 are disposed within the interior 28 and the upper portion 32 may be placed into contact with the one or more walls 26. The leg(s) 30 may have a length that is greater than a height of the wall(s) 26 such that the upper portion 32 may be spaced apart from an upper surface of the wall(s) 26. In some embodiments, a distance between a lower surface of the upper portion 32 is and an upper surface of the wall(s) 26 is sufficiently large such that a hand and/or arm of a user may be received in a window or opening between the wall(s) 26 and upper portion 32.

In some embodiments, the pivoting of the leg(s) 30 may be facilitated by a hinge 34. For example, each leg 30 may be coupled to a hinge, which may be coupled to one of the base portion 22 and/or the support portion 32. In some embodiments, hinges 34 may be omitted and the leg(s) 30 may be removably coupled to both the base portion 22 and the support portion 32. One of ordinary skill in the art will understand that there are numerous other ways in which the fixture may be provided such that it is may be collapsible and/or expandable. In some embodiments, the leg(s) 30 may be configured to have an adjustable length. For example, each of the leg(s) 30 may include at least a first portion and a second portion that are telescopically, slid ably, or otherwise coupled to one another to permit the length of the leg(s) to be adjusted.

Upper portion 32 may have a generally complementary shape to the shape of base portion 22 and may define an opening 36. As best seen in FIGS. 1 and 3, a support projection 38 may extend inwardly into the opening 36. Support projection 38 may be sized and configured to support a camera or other image capture device (not shown in FIG. 1), such as a standalone camera or a camera 124 of the computing device 100, is positioned over the imaging platform 50, as best seen in FIG. 1. In some embodiments, one or more guide rails or features 40 may extend from an upper surface 42 of the upper portion 32. Guide rails 40 may be located to guide a computing device 100 into a proper location relative to the imaging platform. Although guide rails 40 are shown as being in a fixed location along the upper surface 42 of upper portion 32, it should be understood that guide rails 40 may be adjustably positionable relative to the upper surface 42.

In some embodiments, base portion 22 and upper portion 32 may include one or more coupling mechanisms for coupling the upper portion 32 to the base portion 22 when the leg(s) 30 are in the collapsed position. In the example illustrated in FIGS. 1-3, the walls 26 are provided with tabs 44 and upper portion 32 is provided with tabs 46. The tabs 44, 46 may include cooperating members for securing the upper portion 32 to the lower portion 22. For example, the tabs 44, 46 may include magnets, cooperating latches and catches, screw and corresponding threaded hole, dowel and corresponding hole, or other type of coupling mechanism for providing temporary securement of the upper portion 32 to the base portion 22.

Imaging platform 50 may be permanently or releasably coupled to the support surface 24 of the base portion 22. For example, the imaging platform 50 may be glued or otherwise chemically affixed to the support surface 24, or imaging platform 50 may be mechanically coupled to the support surface 24 of the base portion 22, such as through the use of screws or other fasteners. The imaging platform 50 may include a backlit area 52, which may include a screen that is backlit by a light source (not shown). In some embodiments, the backlit area 52 may include a background image, which may include one or more reference markers and/or patterns.

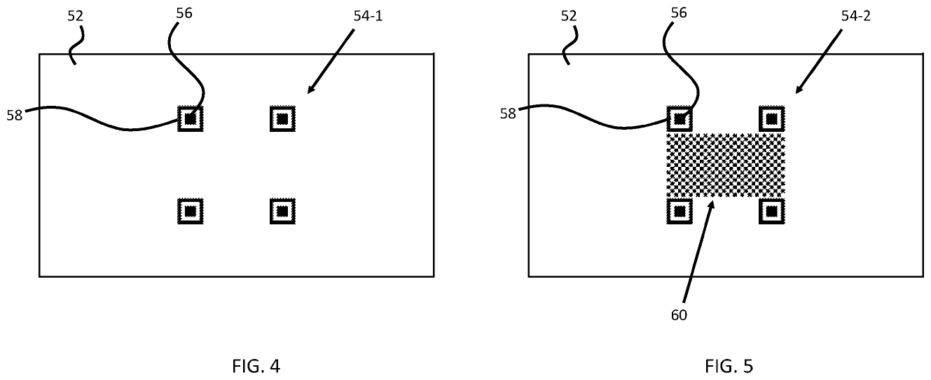

FIGS. 4 and 5 illustrate examples of reference patterns 54-1, 54-2 that may be disposed on or otherwise provided in backlit area 52. For example, in some embodiments, a reference pattern may be printed on the backlit area 52 of the imaging platform. However, in some embodiments, a reference pattern may be printed on a transparent material, which may be removably disposed on the backlit area 52. One of ordinary skill in the art will understand that there may be a variety of other ways for the reference pattern to be disposed on the backlit area 52. Referring first to FIG. 4, reference pattern 54-1 may include four solid squares 56, with each square positioned within a respective box 58. Although four solid squares 56 and four boxes 58 are shown, it should be understood that fewer or more squares and boxes may be provided. Further, it should be understood that objects having other shapes (e.g., circles, triangles, etc.) may be provided. The square and box pairs may be arranged in a square shape with each square and box pair being positioned in a respective corner of the defined square. However, it should be understood that the square and box pairs may be arranged in other geometric arrangements. In some embodiments, the spacing between the square and box pairs may be known and/or the size of a square 56 and/or box 58 may have known dimensions. Providing the reference pattern 54-1 with known dimensions allows the scaling the image, including a lens or other object present in an obtained image, as described herein.

FIG. 5 illustrates another example of a reference pattern 54-2 in accordance with some embodiments. The reference pattern 54-2 may include one or more solid squares 56 and one or more boxes 58, which may be arranged in a similar and/or identical manner to the square and box pairs described above with respect to FIG. 5. An optical pattern 60 may be disposed at least partially between or adjacent to a square and box pair. In the example illustrated in FIG. 5, the optical pattern 60 may include a chess/checkerboard pattern, e.g., a plurality of solid boxes of alternating colors, such as black and white, for example. The optical pattern 60 may be selected to compensate for lens distortion in an extracted shape. Here again, while the optical pattern 60 is described and shown as a chess/checkerboard pattern, it should be understood that other patterns may be used.

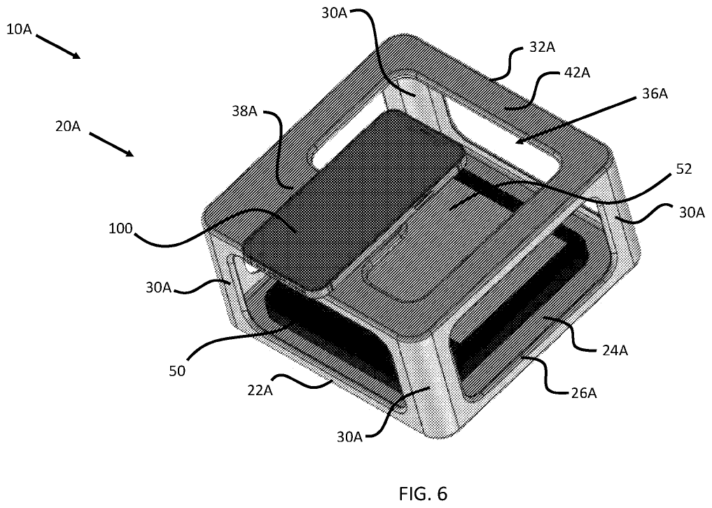

FIGS. 6-8 illustrate another example of a system 10A in accordance with some embodiments. The system 10A may include a fixture 20A and a computing device 100. The fixture 20A may be configured to support computing device 100 at a known distance from a lens (not shown in FIGS. 6-8) as described herein. In some embodiments, the fixture 20A may include a base portion 22A providing a support surface 24A for an imaging platform 50. The base portion 22A may also include one or more walls 26A extending from the support surface 24, although the walls 26A may be omitted. In some embodiments, the one or more walls 26A and support surface 24A may collectively define an interior region or space 28A. Although the base portion 22A is shown having a generally square or rectangular shape, it should be understood that base portion 22A may be provided in other shapes.

Fixture 20A may include one or more legs or spacers 30A, which may couple an upper portion 32A to the base portion 22A. Although four legs 30A are illustrated in FIGS. 6-8, fewer or more legs 30A may be provided. The legs 30A illustrated in FIGS. 6-8 may be permanently connected to base portion 22A and/or upper portion 32A such that fixture 20A is monolithic. However, it should be understood that the legs 30A may be removably coupled to one or both of base portion 22A and upper portion 32A. The leg(s) 30A may have a length that is greater than a height of the wall(s) 26A such that the upper portion 32A may be spaced apart from an upper surface of the wall(s) 26A. In some embodiments, a distance between a lower surface of the upper portion 32A is and an upper surface of the wall(s) 26A is sufficiently large such that a hand and/or arm of a user may be received in a window or opening between the wall(s) 26A and upper portion 32A.

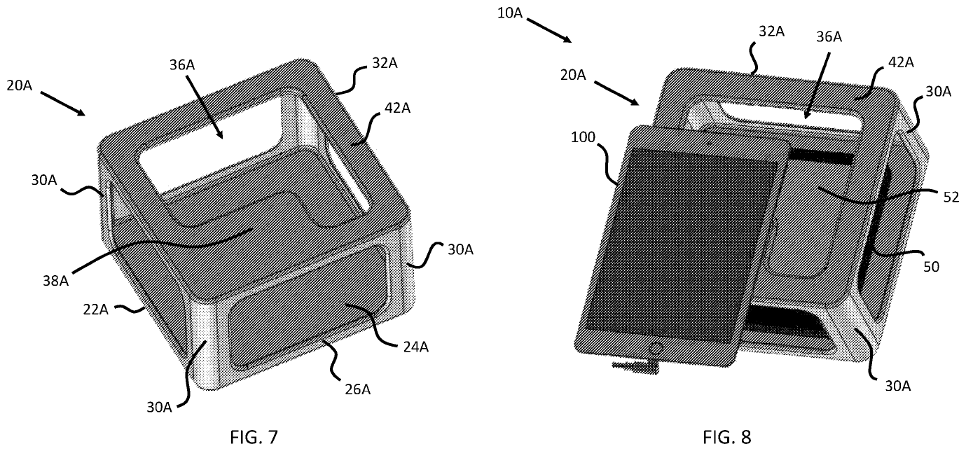

Upper portion 32A may have a generally complementary shape to the shape of base portion 22A and may define an opening 36A. As best seen in FIG. 7, a support projection 38A may extend inwardly into the opening 36A. Support projection 38A may be sized and configured to support a camera, such as a camera of the computing device 100 or a standalone camera (not shown), positioned over the imaging platform 50. Although not shown in FIGS. 6-8, one or more guide rails or features may extend from an upper surface 42A of the upper portion 32A. Guide rails may be located to guide a computing device 100 into a proper location relative to the imaging platform.

As described above with respect to FIGS. 1-3 and system 10, imaging platform 50 may be permanently or releasably coupled to the support surface 24A of the base portion 22A. For example, the imaging platform 50 may be glued or otherwise chemically affixed to the support surface 24A, or imaging platform 50 may be mechanically coupled to the support surface 24A of the base portion 22A, such as through the use of screws or other fasteners. The imaging platform 50 may include a backlit area 52, which may include a screen that is backlit by a light source (not shown). In some embodiments, the backlit area 52 may include a background image, which may include one or more reference markers and/or patterns, such as a reference pattern 54-1, 54-2 as shown in FIGS. 4 and 5.

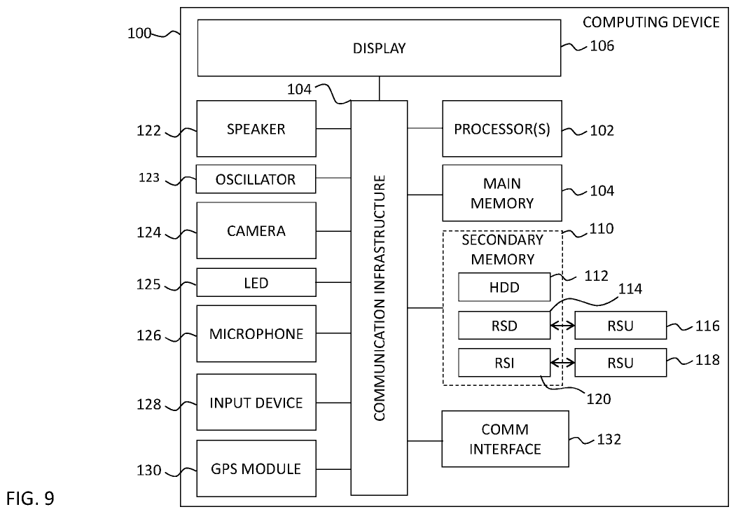

FIG. 9 is a block diagram of one example of an architecture of a computing device 100 that may be used in a system, such as system 10, 10A, in accordance with some embodiments. Computing device 100 may be a cellular phone, a tablet, a desktop computer, a laptop computer, or any other suitable computing device as will be understood by one of ordinary skill in the art. As shown in FIG. 9, computing device 100 may include one or more processors, such as processor(s) 102. Processor(s) 102 may be any central processing unit (“CPU”), microprocessor, micro-controller, or computational device or circuit for executing instructions. Processor(s) may be connected to a communication infrastructure 104 (e.g., a communications bus, crossover bar, or network). Various software embodiments are described in terms of this exemplary computing device 100. After reading this description, it will be apparent to one of ordinary skill in the art how to implement one or more disclosed methods using a mobile computing 100 that may include other architectures and/or components. It should be understood that a computing device 100 implementing one or more of the disclosed methods may include some, all, or additional functional components as those of the computing device 100 illustrated in FIG. 9.

Computing device 100 may include a display 106 that displays graphics, video, text, and other data received from the communication infrastructure 104 (or from a frame buffer not shown) to a user. Examples of such displays 106 include, but are not limited to, LCD screens, LED display, OLED display, touch screen (e.g., capacitive, resistive optical imaging, infrared), and a plasma display, to name a few possible displays. Computing device 100 also may include a main memory 108, such as a random access (“RAM”) memory, and may also include a secondary memory 110. Secondary memory 110 may include a more persistent memory such as, for example, a hard disk drive (“HDD”) 112 and/or removable storage drive (“RSD”) 114, representing a magnetic tape drive, an optical disk drive, solid-state drive (“SDD”), or the like. In some embodiments, removable storage drive 114 may read from and/or writes to a removable storage unit (“RSU”) 116 in a manner that is understood by one of ordinary skill in the art. Removable storage unit 116 may represent a magnetic tape, optical disk, or the like, which may be read by and written to by removable storage drive 114. As will be understood by one of ordinary skill in the art, the removable storage unit 116 may include a tangible and non-transient machine-readable storage medium having stored therein computer software and/or data.

In some embodiments, secondary memory 110 may include other devices for allowing computer programs or other instructions to be loaded into computing device 100. Such devices may include, for example, a removable storage unit (“RSU”) 118 and a corresponding interface (“RSI”) 120. Examples of such units 118 and interfaces 120 may include a removable memory chip (such as an erasable programmable read only memory (“EPROM”)), programmable read only memory (“PROM”)), secure digital (“SD”) card and associated socket, and other removable storage units 118 and interfaces 120, which allow software and data to be transferred from the removable storage unit 118 to computing device 100.

Computing device 100 may also include a speaker 122, an oscillator 123, a camera (or other image capture device or sensor) 124, a light emitting diode (“LED”) 125, a microphone 126, an input device 128, and a global positioning system (“GPS”) module 130. Examples of input device 128 include, but are not limited to, a keyboard, buttons, a trackball, or any other interface or device through which a user may input data. In some embodiments, input device 128 and display 106 are integrated into the same component or device. For example, display 106 and input device 128 may be touchscreen through which a user uses a finger, pen, and/or stylus to input data into computing device 100.

Computing device 100 also may include one or more communication interfaces 132, which allows software and data to be transferred between computing device 100 and external devices such as, for example, another computing device 100 that may be locally or remotely connected to computing device 100. Examples of the one or more communication interfaces 132 may include, but are not limited to, a modem, a network interface (such as an Ethernet card or wireless card), a communications port, a Personal Computer Memory Card International Association (“PCMCIA”) slot and card, one or more Personal Component Interconnect (“PCI”) Express slot and cards, or any combination thereof. The one or more communication interfaces 132 may also include a wireless interface configured for short-range communication, such as near field communication (“NFC”), Bluetooth, or other interface for communication via another wireless communication protocol.

Software and data transferred via the one or more communications interfaces 132 may be in the form of signals, which may be electronic, electromagnetic, optical, or other signals capable of being received by communications interfaces 132. These signals may be provided to communications interface 132 via a communications path or channel. The channel may be implemented using wire or cable, fiber optics, a telephone line, a cellular link, a radio frequency (“RF”) link, or other communication channels. The terms “non-transient computer program medium” and “non-transient computer readable medium” refer to media such as removable storage units 116, 118, or a hard disk installed in hard disk drive 112. These computer program products provide software to computing device 100. Computer programs (also referred to as “computer control logic”) may be stored in main memory 108 and/or secondary memory 110. Computer programs may also be received via the one or more communications interfaces 132. Such computer programs, when executed by a processor(s) 102, enable the computing device 100 to perform the methods discussed herein.

In some embodiments, where the method is partially or entirely implemented using software, the software may be stored in a computer program product as firmware and/or loaded into computing device 100 using removable storage drive 114, hard drive 112, and/or communications interface 132. The software, when executed by processor(s) 102, may cause the processor(s) 102 to perform the functions of the methods described herein. In some embodiments, the method may be implemented primarily in hardware using, for example, hardware components such as application specific integrated circuits (“ASICs”). Implementation of the hardware state machine so as to perform the functions described herein will be understood by persons skilled in the art. In some embodiments, the methods may be implemented using a combination of both hardware and software.

In some embodiments, the image capture device and the imaging platform 50 may be part of the same device. For example, a tablet-style computing device 100 (e.g., iPad) may be placed on its back such that its screen (e.g., display 106) may be pointing up and a lens, eyeglasses frame, or other object to be imaged may be placed upon its surface. The display 106 may be used as a light source and/or to display a reference pattern, such as reference patterns 54 shown in FIGS. 4 and 5. A front-facing camera 124 of the tablet computing device 100, i.e., the camera that is oriented to point in the same direction as the display 106, may be used as the image capture device with the use of a mirror, which may be positioned by or affixed to an upper portion 32, 32A of a fixture 20, 20A. The mirror may be oriented such that it reflects an optical image toward the front-facing camera 124 such that the front-facing camera 124 may obtain an image that includes the lens, frame, or other object to be imaged reflected by the mirror. One of ordinary skill in the art will understand that other configurations are possible.

In another possible example, a UV light source that directs UV light toward an imaging platform 50, which may include a fluorescent reference pattern, may be provided. The UV light source may be coupled to a fixture, such as on an underneath surface of upper portion 32, 32A An optical lens (e.g., translucent lens) may be imaged by a camera or other image capture device and appear darker in an obtained image due to absorption of the incident UV light. One of ordinary skill in the art will appreciate that other light sources and/or imaging techniques may be used.

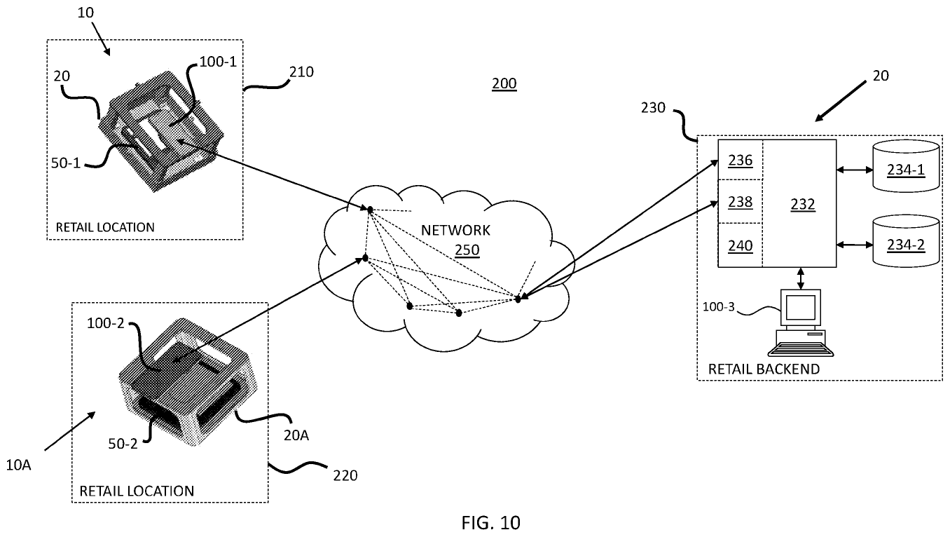

Systems 10, 10A described above may be used as part of a larger system or infrastructure, such as a distributed retail system or infrastructure sales and/or manufacturing system. One example of such a distributed system or infrastructure 200 is shown in FIG. 10. The system 200 may include a first retail location 210, a second retail location 220, and a retail backend location 230 all of which may be communicatively coupled via a network 250. Although two retail locations 210, 220 and a single retail backend location 230 are shown, it should be understood that fewer or additional locations may be provided.

As shown in FIG. 1, the retail location 210 may include a system 10, which may include a fixture 20, an imaging platform 50, and a first computing device 100-1, and the retail location 220 may include a system 10A, which may include a fixture 20A, an imaging platform 50-2, and a second computing device 100-2. It should be understood that the retail locations 210, 220 may include the same fixtures or different fixtures as shown. Further, each location 210, 220 may include additional fixtures and computing devices as will be understood by one of ordinary skill in the art.

Network 250 may be a wide area network (“WAN”), a local area network (“LAN”), personal area network (“PAN”), or the like. In one embodiment, network 250 is the Internet and mobile devices 100 are online. “Online” may mean connecting to or accessing source data or information from a location remote from other devices or networks coupled to network 250. Computing devices 100 may gain access to network 250 through an Internet service provider (not shown). Additionally or alternatively, a computing device 100 may gain access to network 250 through a wireless cellular communication network, a WAN hotspot, or through a wired or wireless connection with another computing device (e.g., a tethered connection) as will be understood by one skilled in the art.

Backend location 230 may include one or more processing units 232 coupled to one or more data storage units 234-1, 234-2 (collectively referred to as “data storage units 324”). The processing unit 232 may provide one or more graphical user interfaces (“GUIs”), e.g., a retail associate GUI or interface 236, a customer GUI or portal 238, and a back-end or administrative GUI or portal 240. The GUIs can take the form of, for example, a webpage that is displayed using a browser program local to one or more of the computing devices 100-1, 100-2, 100-3 (collectively, “computing devices 100”). It should be understood that the retail backend 230 may be implemented on one or more computers, servers, or other computing devices. For example, the retail backend 230 may include servers programmed or partitioned based on permitted access to data stored in data storage units 234. Front- and back-end GUIs 236, 238, 240 may be portal pages that include various content retrieved from the one or more data storage devices 234. As used herein, a “portal” is not limited to general-purpose Internet portals or search engine, such as GOOGLE, but also includes GUIs that may be of interest to specific, limited audiences and that may provide the party access to a plurality of different kinds of related or unrelated information, links and tools as described below. “Webpage” and “website” may be used interchangeably herein. Although not shown, the retail backend 230 may include one or more devices configured to manufacture one or more lenses based on data received from one or more of the computing devices 100 as described herein.

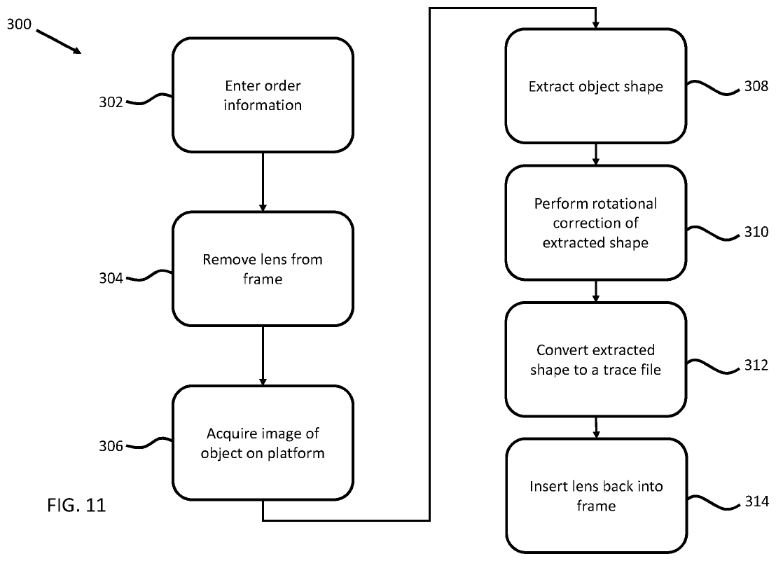

FIG. 11 is a flow diagram of one example of a method of tracing an object in accordance with some embodiments. Although the following description references imaging a lens, it should be understood that other objects, e.g., a frame for eyeglass spectacles, may be imaged Further, it will be apparent that one or more of the blocks described below may be omitted and/or the blocks of the method 300 may be performed in a different order from the manner they are depicted in FIG. 11. Other modifications may be apparent to one of ordinary skill in the art.

At block 302, order information may be entered into an online system. In some embodiments, the order information may be entered into a computing device. For example, the order information may be entered into a computing device 100-1, 100-2 by a sales associate of a retail location 210, 220 (e.g., a store or kiosk), as shown in FIG. 10. The order information may include various types of data, including, but not limited to, a patient's name, address, phone number, email address, eyeglass prescription, frame style (e.g., a SKU), and/or any other information to facilitate the order of spectacles, for example. The computing device 100-1, 100-2 may display one or more GUIs, such as GUI 236, to facilitate the entering of the order information. In some embodiments, a customer may enter some or all of the order information into a computing device via a GUI 238.

At block 304, a lens for the spectacles may be removed from a frame. In some embodiments, the lens may be removed from the frame by the same sales associate that entered the order information into a computing device 100-1, 100-2 at a retail location 210, 220. In some embodiments, a lens may be removed from the frame by a customer or the lens may have already been removed from the frame when the customer arrives at a retail location 210, 220.

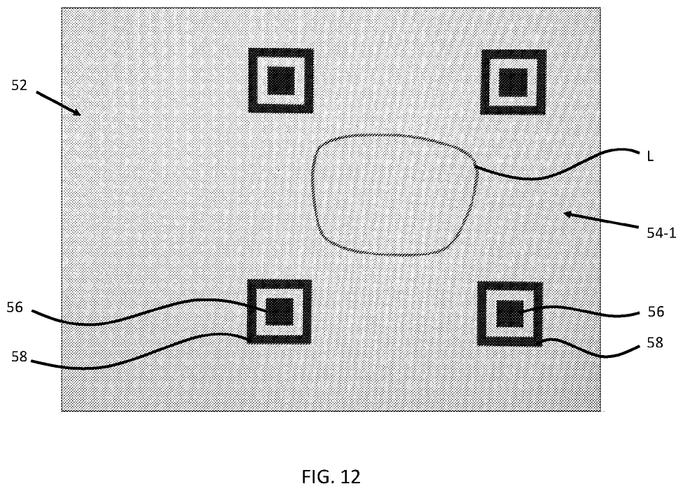

At block 306, an image of the lens or frame is acquired. In some embodiments, the lens or frame is placed on a backlit area 52 of an image platform 50 disposed within a fixture, such as a fixture 20, 20A or other suitable fixture as will be understood by one of ordinary skill in the art. For example, the lens removed from the frame may be placed within the area of a reference pattern, e.g., 54-1, 54-2, of a backlit area 52. In the example shown in FIG. 12, the lens L is placed on the backlit area between in the approximate middle of the reference pattern 54-1, i.e., between the square-box pairs of the reference pattern 54-1. The image platform 50 may be disposed within a fixture, such as a fixture 20 or fixture 20A. A camera, which may be a standalone camera (e.g., an SLR or DSLR camera), a camera 124 of the computing device 100, or other suitable camera, may be used to obtain the image of the lens L when the lens is disposed on the backlit area 52.

At block 308, the shape of the lens L may be extracted from the image. In some embodiments, a shape extraction algorithm may be executed by the computing device 100 of which the camera 124 that obtained the image is a part. In some embodiments, the image of the lens L may be transferred from the camera that obtained the image to a computing device that is remotely located from the camera, e.g., a computing device 100-1, 100-2 located at the retail location 210, 220 or a computing device 100-3 or processor 232 located at the retail and/or manufacturing backend 230. One of ordinary skill in the art will understand that the image may be transferred from a standalone camera using a wired or wireless connection or by transferring the image file using an RSU 116 and/or RSD 118.

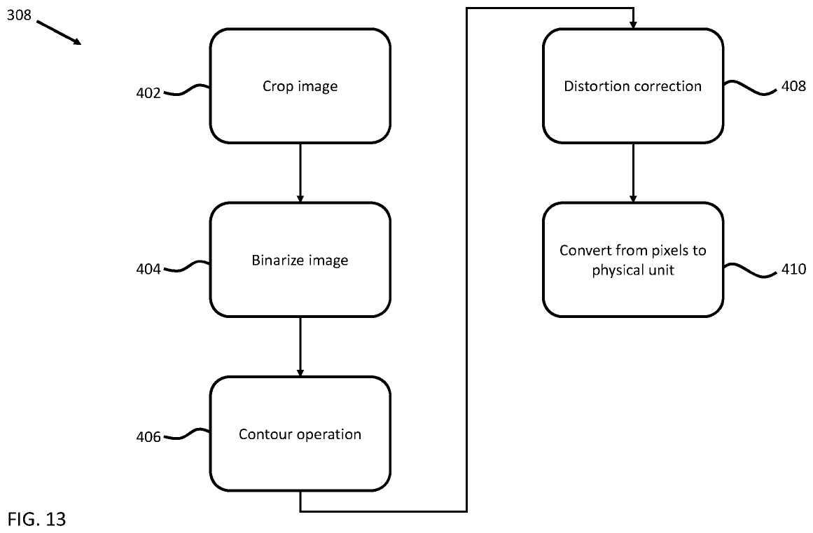

FIG. 13 is a flow diagram of one example of a process for extracting a shape from an image in accordance with some embodiments. The process 308 may be performed, at least in part, by a computing device 100 and/or processor as will be understood by one of ordinary skill in the art.

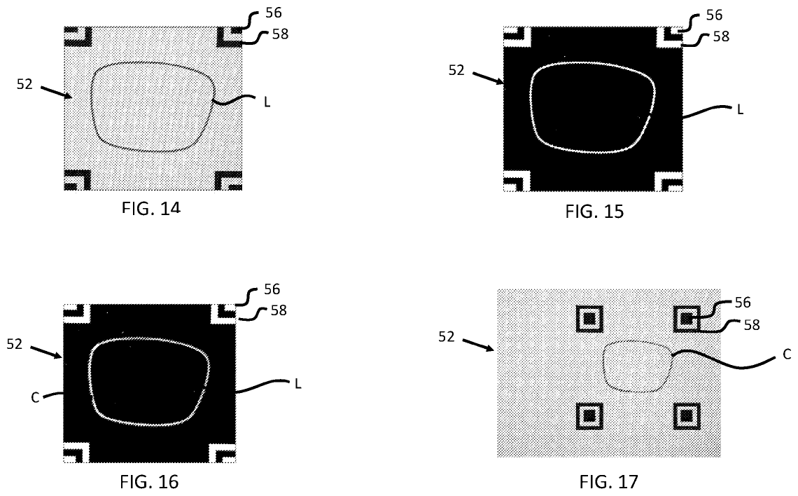

At block 402, the obtained image may be cropped. FIG. 14 illustrates one example of the image illustrated in FIG. 12 having been cropped such that at least a region of interest (“ROI”) is visible in the remaining image. In some embodiments, the ROI may be bounded by all or at least a portion of a reference pattern. For example, in the example illustrated in FIG. 14, the ROI may be bounded by the square-box pairs of a reference pattern 54.

At block 404, the cropped image may be binarized. In some embodiments, binarizing of the image may include performing automatic image thresholding, such as by using Otsu's method or by otherwise determining a greyscale pixel intensity that divides the image into two groups of pixels (e.g., black and white), as will be understood by one of ordinary skill in the art. In some embodiments, the threshold may be determined manually as opposed to using an automatic process. For example, a user of a computing device 100 may be presented with the image on a display, e.g., display 106, along with a slider or other interface. The user may use an input device, e.g., input device 128, to select a threshold that divides the image into two (e.g., black and white), which may correspond to a pixel associated with the lens and a pixel associated with the background. FIG. 15 illustrates one example of the cropped image of FIG. 14 after having been binarized, in accordance with some embodiments. As shown FIG. 15, the pixels in the binarized image corresponding to the lens L and the square-box pairs 56, 58 are white and the other pixels in the image corresponding to the background are black. It should be understood that the colors may be inverted such that the pixels in the binarized image corresponding to the lens L and the square-box pairs are black and the pixels corresponding to the background are white.

At block 406, a contour operation may be performed on the binarized image. The contour operation may identify an inner contour (or boundary) and an outer contour (or boundary) of the lens in the image. As will be understood by one of ordinary skill in the art, various algorithms may be used to identify a contour in an image. One example of such an algorithm is the cv.findContours( ) function, available from OpenCV. In some embodiments, the contours may be identified in the image by identifying all of the continuous points along a boundary having a same color or intensity. In some embodiments, one or more contours may be identified in the image, such as by adding (e.g., drawing) contours in the image. FIG. 16 illustrates an example of an image after a contour operation has been performed. As will be understood by one of ordinary skill in the art, the contour of interest may be the outer contour, i.e., the contour having the larger average dimensions (e.g., radius, diameter, length, etc.), which is the contour emphasized in FIG. 16.

At block 408, one or more distortion correction operations may be performed. As will be understood by one of ordinary skill in the art, distortions may include warping of the image. In some embodiments, distortion correction includes localizing the alignment markers, e.g., the square-box pairs, in the image. There are a number of ways in which the alignment markers may be localized. In one example, given a size parameter, s, a square 56 is assumed to have a size of 3s×3s, with the space between the square 56 and the box 58 assumed to have a width s such that the entire marker size is assumed to have a size of 7s×7s. Based on these assumptions, the alignment markers may be localized with a superposition of box filters of different sizes. For example, letting BN be an unnormalized box filter with a kernel size of Ns×Ns, then the marker detection kernel B may be given by:

$$B = \frac{1}{{S}^{2}} ( - 0.5 {B}_{7} + {B}_{5} - {B}_{3} ) . \qquad Eq . 1$$

The image with the kernel B may be convolved, and the four points with the strongest responses may be identified as the centers of the alignment markers, e.g., box-square pairs. In some embodiments, the best value of s is not known a priori, so different values of s may be tried and the value of s eliciting the strongest response when convolved with the image may be selected.

The location of the alignment markers, e.g., box-square pairs, may be denoted in idealized pattern coordinates as x and the marker locations in the image coordinates may be denoted as X, and there is a transformation H such that

$$X = Hx . \qquad Eq . 2$$

Once x and X are known, then the transformation H may be found via a least squares procedure. The inverse of the transformation (i.e., H⁻¹) may be used to transform the raw extracted lens shape into idealized pattern coordinates.

In some embodiments, a chessboard pattern, such as the pattern 54-2 illustrated in FIG. 5, may be used to correct distortions introduced by a camera. For example, an image of the pattern 54-2 may be obtained, and a computer vision algorithm(s), such as findChessboardCorners( ) and cornerSubPix( ) functions available from OpenCV, may be used to localize the chessboard corners (e.g., the box-square pairs) in the image. The inverse of the transformation, i.e., H⁻¹ may be used to find the chessboard corner locations in the idealized pattern coordinate system.

A distortion field may be found from the difference between the transformed detected corners of the alignment markers and the idealized corners of the alignment markers. A non-uniform interpolation function, such as SciPy's griddata( ) function, may be used to find the corrected lens shape. FIG. 17 illustrates an example of the contour C after extraction. It should be understood that the use of a chessboard pattern and distortion correction may be used in other procedures, including those described herein and without reference to the manner in which the trace is extracted (e.g., contour, radial gradient, etc.).

At block 410, the extracted lens contour C may be converted from dimension and/or coordinates in pixels to a dimensions and/or coordinates in a physical unit of measure (e.g., millimeters, centimeters, inches, etc.). In some embodiments, because the dimensions of the alignment markers, e.g., box-square pairs, these known dimensions may be used to identify a scaling/conversion factor to convert between the pixel dimensions and/or coordinates and dimensions and/or coordinates in a physical unit of measure by multiplying a dimension and/or coordinate by the scaling factor.

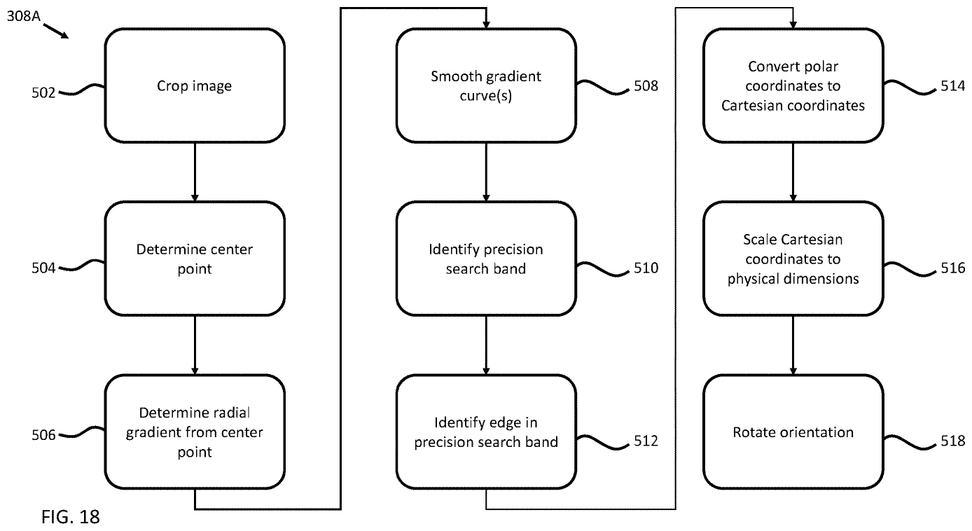

FIG. 18 is another example of a flow diagram of a process for extracting a shape from an image in accordance with some embodiments. The process 308A may be performed, at least in part, by one or more computing devices 100 and/or one or more processors as will be understood by one of ordinary skill in the art. As block 502, the obtained image may be cropped. As discussed above with respect to FIGS. 13 and 14, the obtained image may be cropped to a ROI, which may be an area bound by all or at least a portion of a reference pattern, e.g., an area bounded by the alignment markers (square-box pairs, etc.). In some embodiments, cropping the image may be omitted and the process 308A may begin at block 504.

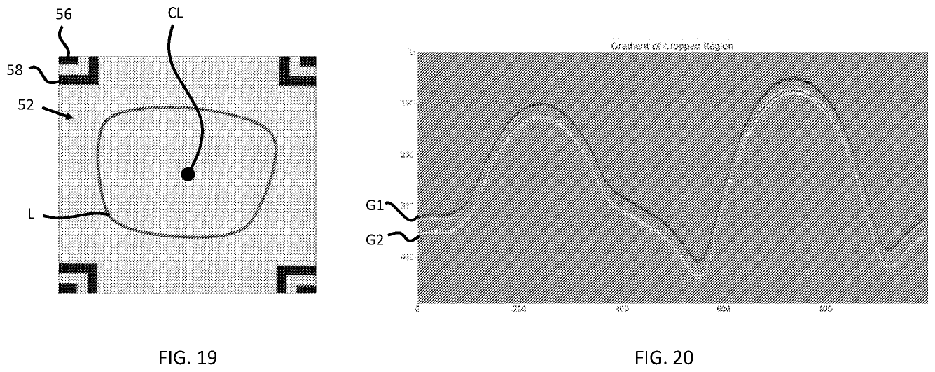

At block 504, a center point may be determined and the image may be converted from Cartesian coordinates to polar coordinates. In some embodiments, the center point is an approximate center of lens L in the obtained image. For example, an associate may attempt to place the lens so that the approximate center of the lens is aligned with a center point between the alignment markers (e.g., square-box pairs) such that the center point of the lens L in the obtained image may be assumed to be (or located closely to) the center point of the alignment markers. FIG. 19 illustrates an example of a cropped image of a lens L with the approximate center of the lens CL being identified.

The conversion of the Cartesian coordinate system to a polar coordinate system may be performed in a number of ways. In some embodiments, the image may be converted to a representation inspired by polar coordinates in which the horizontal axis corresponds to an angle, given by

$$θ = arc tan ( \frac{y}{x} )$$

and the vertical axis corresponds to a magnitude, given by r=\sqrt{x²+y²}. The intensity of each pixel in the output image may be determined by converting the coordinates of the output image to Cartesian coordinates and an interpolation technique, such as SciPy's griddata( ) function, may be used to determine an intensity from the original image. The following pseudo code illustrates one example of implementing such a conversion.

MM, NN = roi.shape
Center = np.array([(NN−1)/2, (MM−1)/2])
# Set up polar coordinates
r_max = int(np.maximum(MM,NN)/2)
r_vec = np.arange(0, r_max)
M = len(r_vec)
# Transform source matrix
theta_vec = np.arange(0, 2*np.pi, 2*np.pi/N)
theta_mat, r_mat = np.meshgrid(theta_vec, r_vec)
xi_mat = r_mat*np.cos(theta_mat)+center[0]
yi_mat = r_mat*np.sin(theta_mat)+center[1]
xiyi_flat = np.vstack((xi_mat flatten( ), yi_mat.flatten( ))).T
# Set up Cartesian coordinates
x_vec = np.arange(0, NN, S)
y_vec = np.arange(0, MM, S)
x_mat, y_mat = np.meshgrid(x_vec, y_vec)
xy_flat = np.vstack((x_mat.flatten( ), y_mat.flatten( ))).T
z_flat = roi.flatten( )

At block 506, the gradient in a radial direction from the center point of the obtained image may be determined. A number of computer vision functions may be used to identify or determine a radial gradient, as will be understood by one of ordinary skill in the art. Such functions identify the change (i.e., gradient) in pixel color or shading. FIG. 20 illustrates an example of two gradients, G1, G2, identified by a radial gradient function in accordance with some embodiments. In some embodiments, determining the radial gradient from the center point at block 506 may include identifying a maximum gradient, e.g., one or more points at which the gradient (e.g., change in pixel color, shading, intensity) is at a maximum. The radial gradient function may identify two gradients, which may correspond to an inner portion of the lens edge and an outer portion of the lens edge. FIG. 21 is one example of an image showing maximum gradients, MG1, MG2, identified by a radial gradient function in accordance with some embodiments.

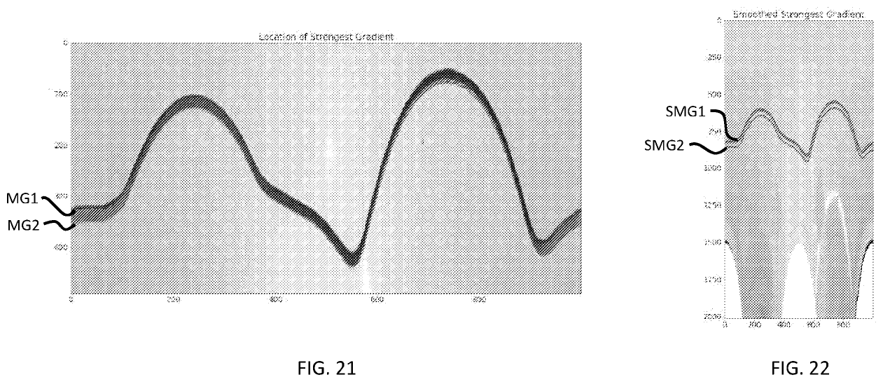

At block 508, the gradient curve(s) may be smoothed. In some embodiments, a smoothing function may be applied to the gradients determined at block 506. For example, a Sobel (Sobel-Feldman) function or filter may be applied to the gradient. As will be understood by one of ordinary skill in the art, applying a smoothing function, such as a Sobel function filter, to the gradients may create an image with emphasized edges. Other functions or filters may be may be applied, such as a Scharr operator or function. FIG. 22 illustrates one example of the gradients, SMG1, SMG2, after a smoothing operation has been performed.

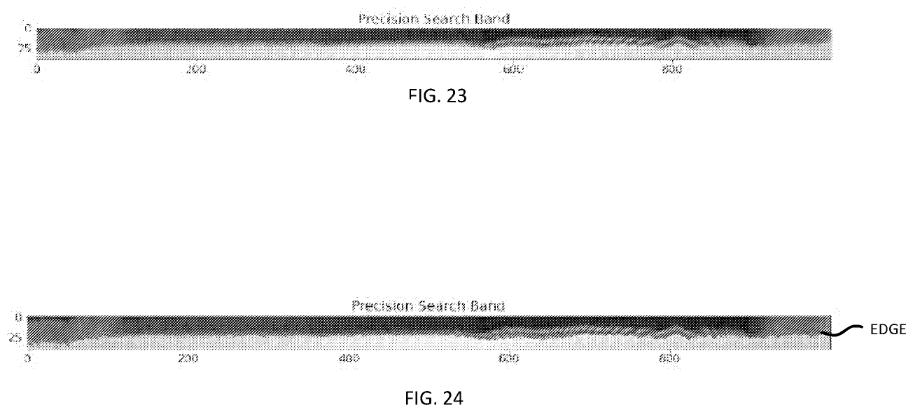

At block 510, a precision search band may be identified. In some embodiments, a precision search band may be identified by defining a bounding box, e.g., limiting the search area to a number of pixels above and below the smoothed gradients identified at block 508. For example, a search area may be defined by setting one boundary a distance (e.g., 10 pixels) above the first smoothed maximum gradient SMG1 and setting another boundary a distance (e.g., 10 pixels) below the second smoothed maximum gradient SMG2. Although 10 pixels are referenced, it should be understood that the precision search area boundary may be defined at an offset that is greater than or less than 10 pixels from the smoothed maximum gradients. FIG. 23 illustrates one example of a precision search band in accordance with some embodiments.

At block 512, the precision search band may be searched to identify a gradient edge. In some embodiments, the gradient edge may be identified using the same search methodology used to determine the radial gradient as described above with respect to block 506. In some embodiments, an estimator may be used to fit a sigmoid function to each vertical column in the precision search area using a least mean squares regression. In some embodiments, the sigmoid function may be given by:

$$y = \frac{L}{1 + np \cdot exp ( - k * ( x - x 0 ) )} + b . \qquad Eq . 3$$

The edge of the lens may align with the steepest part of a sigmoid curve, which may be identified by taking the derivative of the curve and solving for the maximizing argument. FIG. 24 illustrates one example of a gradient edge, EDGE, identified within a precision search band in accordance with some embodiments. The gradient EDGE may be assumed to be the edge of the lens in polar coordinates.

At block 514, the polar coordinates for the lens edge, EDGE, may be converted to Cartesian coordinates. As will be understood by one of ordinary skill in the art, the conversion from polar coordinates to Cartesian coordinates may be achieved by performing the inversion of the Cartesian coordinates to polar coordinates as discussed above with respect to block 504.

At block 516, the Cartesian coordinates may be scaled to determine the physical dimensions of the lens. In some embodiments, determining the physical dimensions of the lens may include identifying a reference object in the image and determining a scale factor to convert between a pixel size to a physical unit of measure (e.g., mm, cm, inch, etc.). For example, an alignment marker may have a known dimension and thus may be used to determine a scale factor. The coordinates may be multiplied by the scale factor to determine the physical dimensions/coordinates for the lens.

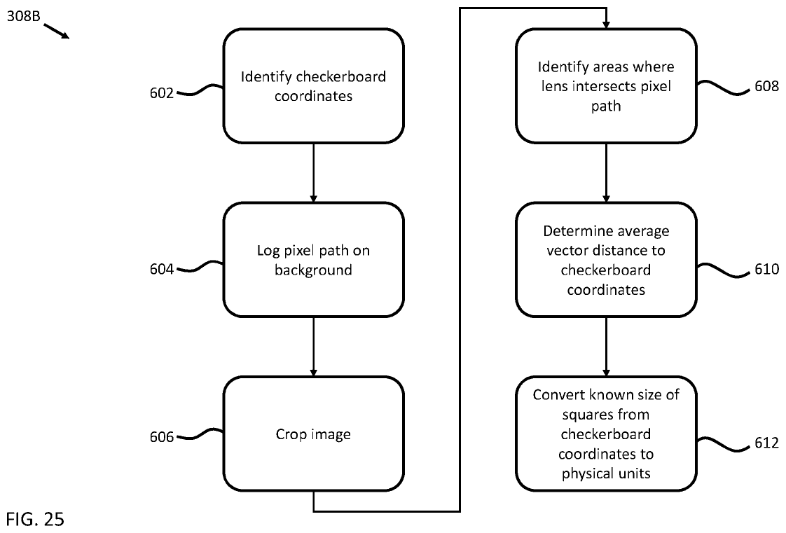

FIG. 25 is another example of a flow diagram of a process for extracting a shape from an image in accordance with some embodiments. The process 308B may be performed, at least in part, by a computing device 100 and/or one or more processors as will be understood by one of ordinary skill in the art. At block 602, the coordinates of a plurality of boxes of a checkerboard pattern may be identified. For example, a reference pattern, such as the reference pattern 54-2 shown in FIG. 5, may include a plurality of boxes arranged in a checkerboard pattern and coordinates for a plurality of boxes in the checkerboard pattern may be determined.

At block 604, a “pixel path” through the checkerboard pattern may be logged. For example, a relationship between the coordinates of the boxes of the checkerboard pattern and the pixels may be determined and stored. It should be understood that the processes performed at blocks 602 and 604 may be performed prior to an image of the lens on the background is obtained.

At block 606, the obtained image, which includes the lens disposed on the reference pattern, may be cropped. As described above, the image may be cropped to a region of interest, which may include all or part of the boundaries of the reference pattern (e.g., square-box pairs).

At block 608, locations at which the edge of the lens intersects the reference pattern may be determined. For example, the locations at which the edge of the lens intersects the boxes of a checkerboard pattern may be determined. In some embodiments, the intersection points are determined by performing a contour operation and logging the locations at which the contour intersects with the boxes (or other geometric shape) of the reference pattern.

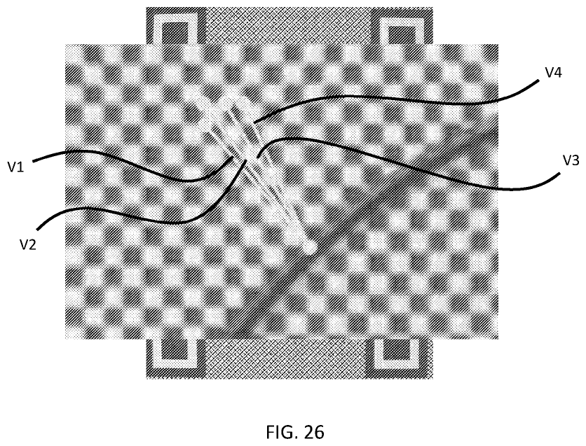

At block 610, an average vector distance to the checkerboard coordinates may be determined. For example and with reference to FIG. 26, a plurality of vectors (e.g., V1, V2, V3, V4) from a box of the checkerboard pattern to a location at which the lens edge intersects the reference pattern may be determined. The averages of these vectors may be obtained to estimate the locations of the edge of the lens. Using multiple vectors and averaging the coordinates of the intersection may yield a more accurate determination of the edge locations.

At block 612, the coordinates of the lens edge in pixels may be converted to physical measurements (e.g., mm, cm, inches, etc.). In some embodiments, the conversion may be obtained using data derived at blocks 602 and/or 604. In some embodiments, a scaling factor may be used to perform the conversion as described above with respect to block 516 of FIG. 18.

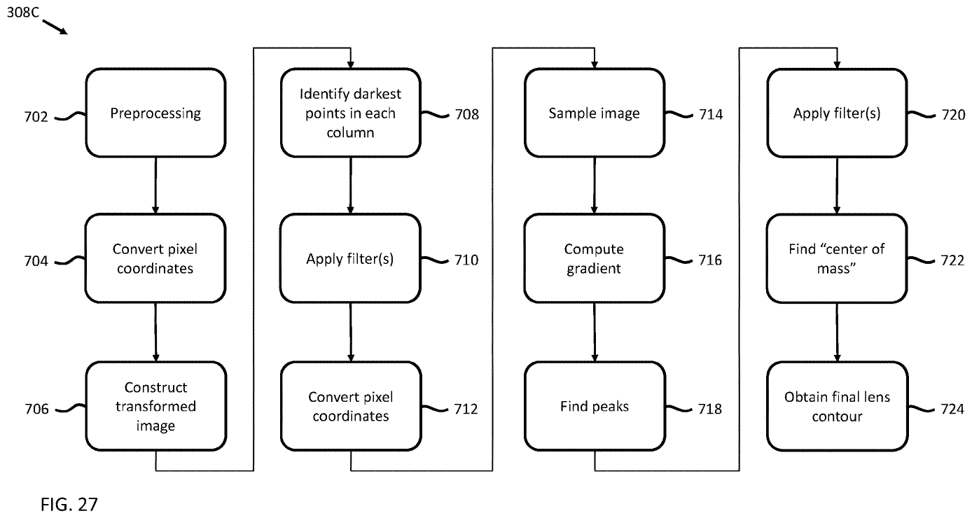

FIG. 27 is another example of a flow diagram of one example of extracting a shape from an image in accordance with some embodiments. The process 308C may be performed, at least in part, by one or more computing devices 100 and/or one or more processors as will be understood by one of ordinary skill in the art. At block 702, preprocessing of the image may be performed. In some embodiments, preprocessing of the image may include cropping of the image to a ROI. For example, the cropping performed at block 702 may be similar to the cropping operations described above with respect to block 402 of FIG. 13, block 502 of FIG. 18, and block 606 of FIG. 25, for example.

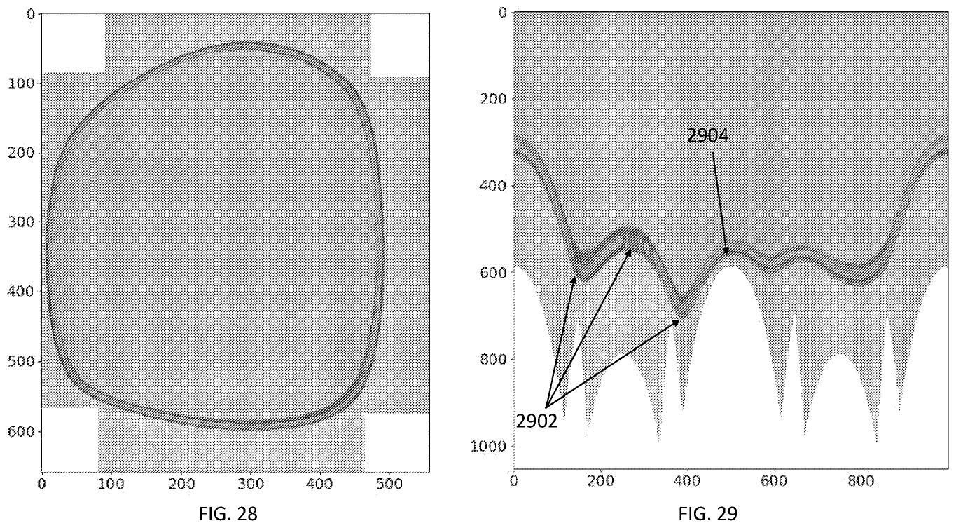

The preprocessing performed at block 702 may also include image downsampling. The image downsampling may be performed to reduce the processing time for the rest of the processing performed on the image. In some embodiments, downsampling by a factor of S in each dimension may be preceded by image blurring using a kernel of size S×S pixels. A person of ordinary skill in the art will understand that other image blurring techniques may be used. FIG. 28 illustrates one example of an image of a lens after preprocessing, in accordance with some embodiments.

Once the preprocessing has been performed, a preliminary contour extraction operation may be performed. In some embodiments, the preliminary contour extraction may be performed in accordance with blocks 704-712 of FIG. 27. It should be appreciated that preliminary contour extraction may include fewer or additional processing steps than those set forth in FIG. 27.

At block 704, the image pixels may be converted from a first coordinate type to a second coordinate type. For example, the image pixel coordinates may be converted from a Cartesian coordinate system to a polar coordinate system. In some embodiments, the center of the polar coordinate system may be placed at the center of the cropped image.

At block 706, a transformed version of the image may be constructed. For example, the horizontal axis of the image may be transformed to correspond to the polar angle, and the vertical axis of the image may be transformed to correspond to the polar magnitude. A person of ordinary skill in the art will understand that other transforms may be used.

At block 708, the darkest point in one or more columns may be identified. For example, with the image converted to polar coordinates, each column may correspond to a radial position around the center point identified at block 704. The identification of the darkest point may be determined by comparing a darkness value of each pixel within a particular column.

At block 710, one or more filters may be applied. For example, a median filter and/or a rectangular filter may be applied to the row indices of the darkest points identified at block 708 to mitigate the impact of any outliers. A person of ordinary skill in the art will understand that application of the filter(s) may take into account the cyclical nature of polar coordinates. FIG. 29 illustrates one example of the output of the preliminary contour extraction. Reference numeral 2902 identifies the locations of the transformed coordinates with the darkest pixel in each column, and reference numeral 2904 identifies the result of the filtering output.

At block 712, the coordinates of the image may be transformed from one coordinate system to another coordinate system. For example, the coordinates may be transformed from the polar coordinate system to the Cartesian coordinate system. The output of block 712 may correspond to the output of the preliminary contour extraction process, which may be followed by a refined contour extraction process. In some embodiments, a refined contour extraction process may include blocks 714-724 of FIG. 27, although it should be understood that other refined contour extraction processes may be used.

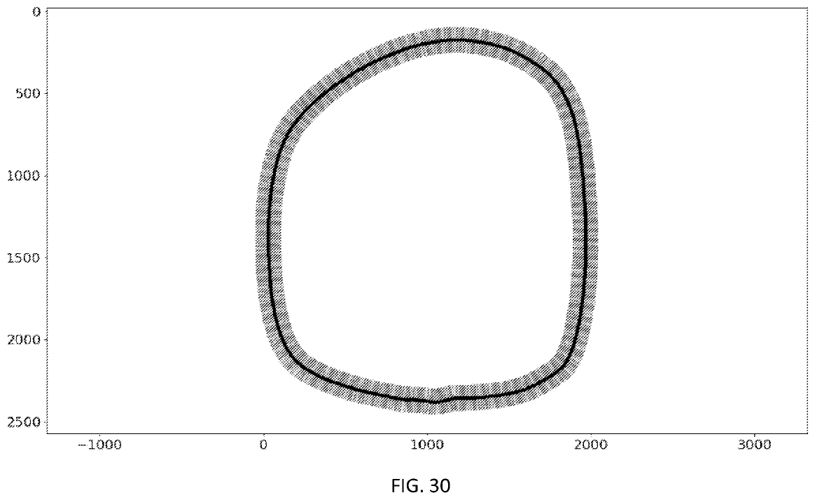

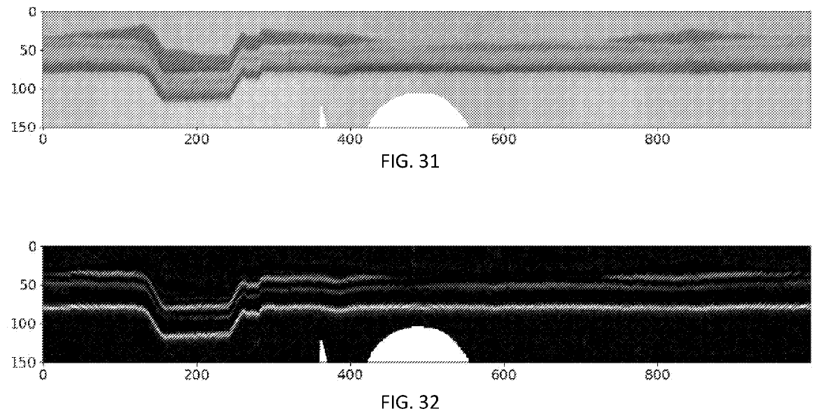

At block 714, the image may be sampled. For example, for each point in the contour, such as the contour output from block 712, a line segment normal to the contour may be sampled and the sampled values may be used to populate the columns of a new transformed image. FIG. 30 illustrates one example illustrating the manner in which the sampling of the contour may be performed at block 714. FIG. 31 illustrates one example of the output of the sampling function performed at block 714.

At block 716, a gradient of the sampled image may be computed. In some embodiments, a gradient is computed along the columns of the transformed image. The gradient values may be clamped less than zero to zero such that only positive gradients may be considered. Other gradients or ranges of gradients may be used. FIG. 32 illustrates one example output of block 716, as applied to the image shown in FIG. 31.

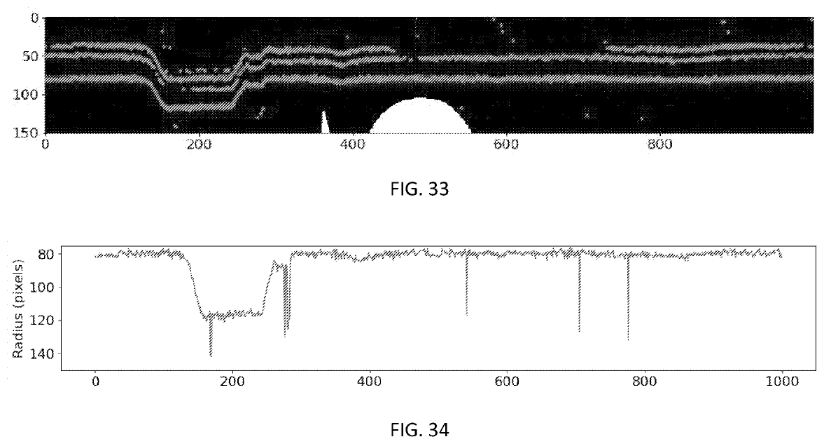

At block 718, gradient peaks may be identified. In some embodiments, a peak-finding function, such as SciPy's (www.scipy.org) find_peaks( ) function, may be used to identify the gradient peaks. Of course it should be understood that the method is not limited to using only SciPy's peak-finding function and that other peak-finding functions may be used. FIG. 33 illustrates one example of the peaks in the image illustrated in FIG. 32, and FIG. 34 identifies the output of a peak-finding function when applied to the image shown in FIG. 32 with the y-axis corresponding to the radius in pixels and the x-axis corresponding to the radial angle bin.

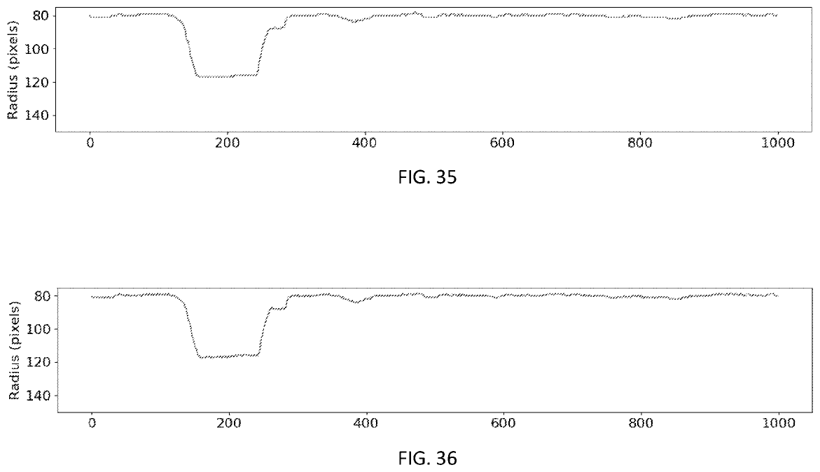

At block 720, one or more filters may be applied to the indices of the peaks. In some embodiments, a median filter may be applied to the indices of the peaks in each column to mitigate the impact of outliers. A person of ordinary skill in the art will understand that the cyclical nature of polar coordinates may be taken into account when applying the filter(s). FIG. 35 identifies one example of the output of block 720 with the y-axis corresponding to the radius in pixels and the x-axis corresponding to the radial angle bin.

At block 722, a “center of mass” may be identified in each column. Such a process may be used to obtain the contour coordinates with subpixel precision. For example, the “center of mass” of the clamped gradient may be identified around the peak. A person of ordinary skill in the art will understand that identifying the “center of mass” may include identifying the location of the approximate center of the clamped gradient within each column. FIG. 36 identifies one example of the output of block 722 with the y-axis corresponding to the radius in pixels and the x-axis corresponding to the radial angle bin.

At block 724, the final lens contour may be obtained. In some embodiments, obtaining the final lens contour may include converting the image from one coordinate system to another coordinate system. For example, the polar coordinates may be converted to Cartesian coordinates.

Referring again to FIG. 11, once the object shape has been extracted from the image, the orientation of the extracted object (e.g., lens, frame, etc.) may be rotated at block 310. In examples in which the extracted shape is of a lens, the extracted shape may be rotated such that the extracted lens shape may be mapped to glass (or other lens substrate) for cutting. In some embodiments, rotating the extracted lens may include accessing a reference style for a type of lens and comparing the extracted lens to the reference style. For example, the reference style may be determined from the order information entered at block 302 in FIG. 11. As described above, the order information may include a frame style (e.g., a SKU), along with other information that may be relevant to determine a reference lens. The dimensions and/or coordinates for the extracted lens may be compared to the dimensions and/or coordinates for the reference lens and the dimensions and/or coordinates for extracted lens may be adjusted (e.g., rotated) to minimize the difference between the coordinates for the extracted lens and the coordinates for the reference lens. One of ordinary skill in the art will understand that the extracted lens may be rotated using other techniques.

At block 312, the extracted (and rotated) object may be converted to a trace file. One of ordinary skill in the art will understand that the trace file may include instructions for performing one or more machining operations. For example, the data (e.g., list of coordinates) corresponding to the edge/perimeter of the lens may be transformed into a file type that may be read and acted upon by an automated lens cutting apparatus. The file may be transferred to a lens cutting machine, which may be located on the premises of a retail location 210, 220 or at a retail/manufacturing backend location 230.

At block 314, the lens may be placed back into the frames. As will be understood the process shown in FIG. 11 may be repeated for each lens or the frame.

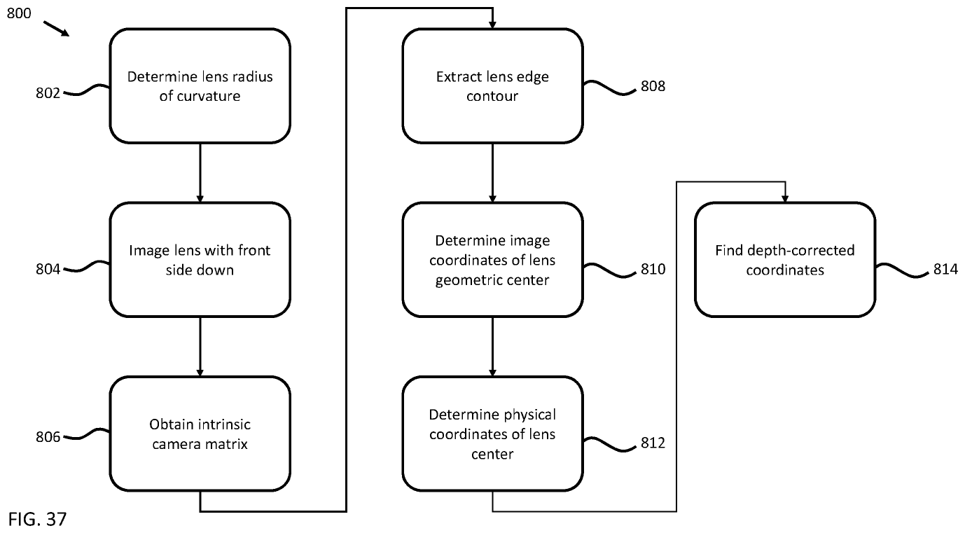

In some embodiments, the distance a camera is from the lens when the image is acquired may affect the accuracy of the lens of the extraction method. For example, small differences in an edge depth of a lens may affect the apparent shape of the lens edge in an image. Further, small differences between the edge depth and the scale reference pattern can affect the apparent size of the lens edge in an image. This may be particularly true when a focal length of a camera is large and the camera is positioned close to a lens when the image is obtained. While it may be desirable to have the camera positioned close to the lens for a compact imaging configuration, this may increase the inaccuracies induced due to the depth difference between the lens edge and the scale reference marker and variations in edge depth. Consequently, in some embodiments, a process, such as the process 800 illustrated in FIG. 37, may be performed to improve the accuracy of the extracted lens shape. Process 800 may be performed, at least in part, by one or more computing devices 100 and/or one or more processors as will be understood by one of ordinary skill in the art.

At block 802, the radius of curvature of the lens to be imaged may be determined. In some embodiments, the radius of curvature may be known, such as provided from the manufacturer of the lens. In some embodiments, the radius of curvature may be determined by measuring the front side base curve of the lens to be imaged and then calculating the radius of curvature, r.

At block 804, the lens may be imaged. In some embodiments, the lens may be imaged with the front of the lens facing down. Eyeglasses lenses typically have a generally spherical shape. Accordingly, when the lens is front side facing down, the depth of the difference between the point of contact with the surface and the lens edge may be determined using the radius of curvature of the lens.

At block 806, an intrinsic camera matrix may be obtained. For example, an intrinsic camera matrix may be obtained by performing a camera resection process, such as estimating the parameters of a pinhole camera model given a photograph or video. As will be understood by one of ordinary skill in the art, camera resectioning may include determining the pose of a pin hole camera. In some embodiments, the following calculations may be performed to obtain the intrinsic camera matrix: (1) a focal length, F, in pixels may be calculated using the following equation:

$$F = ( \frac{S}{s} ) d \qquad Eq . ( 4 )$$

where,
   d is the distance, in millimeters, between the camera and the background;
   S is the distance, in pixels, between alignment markers; and
   s is the distance, in millimeters, between alignment markers.

In some embodiments, it may be assumed that the camera's principal point, C, is at the center of the image and having the coordinates

$$C = ( \frac{N - 1}{2} , \frac{M - 1}{2} ) ,$$

where N is the number of columns in an image and M is the number of rows in the image.

At block 808, the lens edge contour may be extracted using computer vision. Any suitable lens extraction method, such as those lens extraction methods described above, may be used to extract the lens edge contour at block 808.

At block 810, the image coordinates of the geometric center, G, in pixels, of the lens may be determined.

At block 812, the physical coordinates of the geometric center, g, in millimeters of the lens may be determined from the geometric center, G, in pixels using the following equation:

$$g = ( \frac{d}{F} ) ( G - C ) . \qquad Eq . ( 5 )$$

At block 814, the depth-corrected coordinates may be determined. In some embodiments, determining the depth-corrected coordinates may include performing the following calculations. For example, the depth of the lens edge, at each of the physical coordinates of the ith point of the lens contour, pᵢ′, may be expressed as:

$$z ( {p}_{i}^{′} ) = d - ( r - \sqrt{{r}^{2} - {‖ {p}_{i}^{′} - g ‖}^{2}} + δ ) . \qquad Eq . ( 6 )$$

where,
   δ is the depth difference between the front side edge and a bevel edge, in millimeters.

The value of the depth-corrected physical coordinates pᵢ′ that minimizes the error metric, may be numerically solved using the following equation:

$$ϵ = ‖ {p}_{i}^{′} - [ \frac{z ( {p}_{i}^{′} )}{F} - ( {P}_{i} - C ) ] ‖ \qquad Eq . ( 7 )$$

where,
   Pᵢ is the image coordinates of the ith point of the lens edge contour in pixels.

Finally, the depth-corrected image coordinates may be given by the following expression:

$${P}_{i}^{′} = ( \frac{F}{d} ) {p}_{i}^{′} + C$$

The disclosed systems and methods advantageously enable a lens and/or frame for eyeglasses to be imaged without expensive lens-imaging equipment, which may not be located at each retail establishment. Additionally, the disclosed systems and methods may reduce the lead time required to replace a lens for a pair of eyeglasses compared to conventional methods where the lenses may be sent to an offsite location for tracing and cutting.

All or part of the present invention can be embodied in the form of methods and apparatus for practicing those methods. The present invention can also be embodied in the form of program code embodied in tangible media, such as floppy diskettes, CD-ROMs, DVD-ROMs, Blu-ray disks, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

1. A method, comprising:
obtaining an image of an object disposed on a reference pattern;
identifying a search band in the image;
identifying a plurality of locations within the search band, each of the plurality of locations corresponding to an edge of the object in the image; and
storing a trace for the object extracted from the in a computer-readable storage medium.

2. The method of claim 1, further comprising:
determining a radial gradient in the image with respect to a reference point,
wherein the search band in the image is identified based on the radial gradient.

3. The method of claim 2, further comprising, prior to determining the radial gradient in the image, converting the image from a first coordinate system to a second coordinate system.

4. The method of claim 3, wherein the first coordinate system includes a Cartesian coordinate system, and wherein the second coordinate system includes a polar coordinate system.

5. The method of claim 3, further comprising, prior to storing the trace for the lens, converting the plurality of locations within the search band from the second coordinate system to the first coordinate system.

6. The method of claim 5, further comprising, prior to storing the trace for the lens, adjusting an orientation of the trace of the lens.

7. The method of claim 6, wherein adjusting the orientation of the trace of the lens includes:
comparing a preliminary trace for the lens with a reference trace; and
identifying a rotation angle for the preliminary trace based on the comparison.

8. The method of claim 2, wherein identifying the search band based on the radial gradient includes limiting a region of interest to a predetermined amount pixels from a determined radial gradient.

9. The method of claim 1, further comprising:
identifying a contour in the image,
wherein identifying the search band in the image including identifying a number of pixels at a predetermined distance from the contour.

10. The method of claim 1, wherein the object includes a lens.

11. The method of claim 1, wherein the object includes frames for eyeglasses.

12-22. (canceled)

23. A system, comprising:
a camera;
a fixture including:
a backlit area having a reference pattern and configured to support an object,
a support surface configured to support the camera at a distance from the backlit area; and
a computing device in signal communication with the camera, the computing device configured to:
obtain an image from the camera, the image including the object and the reference pattern, and
extract a trace of the object from the image.

24. The system of claim 23, wherein the camera is a component of the computing device.

25. The system of claim 23, wherein the camera is communicatively coupled to the computing device via at least one of a wired or wireless connection.

26. The system of claim 23, wherein to extract the trace of the object from the image, the computing device is configured to:
determine a radial gradient in the image with respect to a reference point;
identify a search band based on the radial gradient; and
identify a plurality of locations within the search band, each of the plurality of locations corresponding to an edge of the object in the image.

27. The system of claim 26, wherein the object includes a lens for eyeglasses.

28. The system of claim 26, wherein the object includes a frame for eyeglasses.

29. A method, comprising:
placing an object over a reference pattern disposed on a backlit area of an imaging platform;
obtaining an image of the object on the reference pattern using a camera; and
extracting a trace of the object from the image using a computing device that is communicatively coupled to the camera.

30. The method of claim 29, wherein the object includes a lens for eyeglasses, the method further comprising:
removing the lens from an eyeglass frame prior to placing the lens over the reference pattern; and
inserting the lens into the eyeglass frame after obtaining the image
wherein the lens is placed on the imaging platform such that a concave side of the lens is placed on the imaging platform.

31. (canceled)

32. (canceled)

33. The method of claim 29, wherein the object includes a frame for eyeglasses.
